(19) United States
(12) Patent Application Publication
(10) Pub. No.: US 2014/0198118 A1
(43) Pub. Date: Jul. 17, 2014

(54) IMAGE BROWSING METHOD, SYSTEM AND COMPUTER STORAGE MEDIUM

(71) Applicants: Yuan Huang, Guangdong (CN); Yongjian Wu, Guangdong (CN); Zongyao Tang, Guangdong (CN); Yucun Pan, Guangdong (CN)

(72) Inventors: Yuan Huang, Guangdong (CN); Yongjian Wu, Guangdong (CN); Zongyao Tang, Guangdong (CN); Yucun Pan, Guangdong (CN)

(73) Assignee: TENCENT TECHNOLOGY (SHENZHEN) COMPANY LIMITED, Guangdong (CN)

(21) Appl. No.: 14/112,197

(22) PCT Filed: Aug. 13, 2012
(86) PCT No.: PCT/CN2012/080028

§ 371 Date: Dec. 6, 2013

(30) Foreign Application Priority Data
Sep. 29, 2011 (CN) 201110295468.4

(51) Int. Cl. G06T 1/60

(52) U.S. Cl. CPC G06T 1/60
USPC 345/557

(57) ABSTRACT

An image browsing method, system and computer storage media are disclosed. The method includes: obtaining a user's operation request for an image; comparing the operation request with a preset condition, and determining whether to cache the image into a main cache. When it is required to cache the image into the main cache, further determining whether it is the first time that the image is rendered; if yes, employing a main thread to cache the image into the main cache, to obtain the image from the main cache, and to render the image. Otherwise, employing a main thread to obtain an image adapted to the capacity of the main cache from an image chain, and to render the image; and displaying the image rendered. This avoids unsmooth browsing of the image due to time-consuming creation of the images to be rendered, thereby allowing smooth image browsing.

### CROSS REFERENCE TO RELATED APPLICATIONS

This application is a National Stage of International Application PCT/CN2012/080028, filed on Aug. 13, 2012, which claims the benefit of Chinese Patent Application No. 201110295468.4, filed on Sep. 29, 2011. The entireties of both applications are hereby incorporated by reference.

### FIELD OF THE INVENTION

The present invention relates generally to the field of image processing, and more particularly to an image browsing method, system and computer storage medium.

### BACKGROUND OF THE INVENTION

When browsing images, users often perform various operations to images, such as scaling, dragging and switching.

However, if a conventional image viewer, such as Windows Picture and Fax Viewer, is used to browse an image of high resolution, interpolation arithmetic operation directed to the image will be very slow, due to the absence of appropriate image caching and optimization, which leads to unsmooth scaling and dragging operation of the image, or even not responding.

### SUMMARY OF THE INVENTION

Based on the above, there is a need to provide an image browsing method, which enables smooth browsing of images.

A method for image browsing includes the steps of:

obtaining a user's operation request for an image;

comparing the operation request with a preset condition, and determining whether it is required to cache the image into a main cache;

when it is required to cache the image into the main cache, further determining whether it is the first time that the image is rendered; if yes, employing a main thread to cache the image into the main cache, to obtain the image from the main cache, and to render the image; otherwise, employing a main thread to obtain an image adapted to the capacity of the main cache from an image chain, and to render the image; and

displaying the image rendered.

In one embodiment, the method may further include the step of:

when it is not required to cache the image into the main cache, employing a main thread to obtain the image directly from the main cache, and to render the image.

In one embodiment, the step of obtaining an image adapted to the capacity of the main cache from an image chain may include: determining whether an image chain of the image has been created; if yes, employing the main thread to obtain an image adapted to the capacity of the main cache from the image chain, and to render the image; otherwise, employing the main thread to create the image chain, to obtain an image adapted to the capacity of the main cache from the image chain, and to render the image.

In one embodiment, the method may further include, after determining whether an image chain of the image has been created, the step of: determining whether the image chain is in a sub-cache; if yes, employing the main thread to obtain an image adapted to the capacity of the main cache from the image chain in the sub-cache, and to render the image; otherwise, employing the main thread to cache the image chain created into the sub-cache; when it is determined that the image chain of the image has not yet been created, employing the main thread to create an image chain of the image, to cache the image chain created into a sub-cache, to obtain the image adapted to the capacity of the main cache from the image chain in the sub-cache, and to render the image.

In one embodiment, the preset condition may be selected from any of the followings:

it is the first time that an image is rendered;

the size of the image is larger than the capacity of the main cache; and

the user is performing operations of image scaling or dragging.

In one embodiment, when it is required to cache an image into the main cache, and it is not the first time that an image is rendered, the method further includes the step of: employing a sub-thread to create an image, and to cache the image created into the main cache; employing the main thread to obtain the image created from the main cache, and to render the image.

Furthermore, there is also a need to provide a system for image browsing, which enables smooth browsing of images.

A system for image browsing, includes:

an obtaining module, configured to obtain a user's operation request for an image;

a determining module, configured to compare the operation request with a preset condition, and to determine whether it is required to cache the image into a main cache, and whether it is the first time that an image is rendered;

when the determining module determines that it is required to cache the image into the main cache, and it is the first time that the image is rendered, a rendering module employs a main thread to cache the image into the main cache, to obtain the image from the main cache, and to render the image; when the determining module determines that it is required to cache the image into the main cache, and it is not the first time that the image is rendered, the rendering module employs the main thread to obtain an image adapted to the capacity of the main cache from an image chain, and to render the image; and

a display module, configured to display the image rendered.

In one embodiment, when the determining module determines that it is not required to cache the image into the main cache, the rendering module employs the main thread to obtain the image directly from the main cache, and to render the image.

In one embodiment, the determining module is also configured to determine whether an image chain of the image has been created; if yes, the main thread module is configured to obtain an image adapted to the capacity of the main cache from the image chain, and to render the image; otherwise, the main thread module is configured to create an image chain, to obtain an image adapted to the capacity of the main cache from the image chain, and to render the image.

In one embodiment, the determining module is also configured to further determine, after determining that the image chain of the image has been created, whether the image chain is in a sub-cache; if yes, the rendering module employs the main thread to obtain an image adapted to the capacity of the main cache from the image chain in the sub-cache, and renders the image; otherwise, the rendering module employs the main thread to cache the image chain created into the sub-cache; when the determining module determines that the image chain of the image hasn't been created yet, the rendering module employs the main thread to create the image chain, to cache the image chain created into a sub-cache, then to obtain the image adapted to the capacity of the main cache from the image chain in the sub-cache, and renders the image.

In one embodiment, the preset condition is selected from any of the followings:

it is the first time that an image is rendered;

the size of the image is larger than the capacity of the main cache; and

the user is performing operations of image scaling or dragging.

In one embodiment, when the determining module determines that it is required to cache the image into the main cache, and it is not the first time that an image is rendered, the rendering module employs a sub-thread to create an image, and to cache the image created into the main cache; then the rendering module employs the main thread to obtain the image created from the main cache, and renders the image.

Furthermore, there is still a need to provide a computer storage medium.

A non-transitory computer-readable storage medium storing computer-executable instructions which, when executed by one or more computer processors, causes the one or more computer processors to perform a method of image browsing. The method includes the steps of:

obtaining a user's operation request for an image;

comparing the operation request with a preset condition, and determining if it is required to cache the image into a main cache;

when it is required to cache the image into the main cache, further determining if it is the first time that the image is rendered; if yes, employing a main thread to cache the image into the main cache, to obtain the image from the main cache, and to render the image; otherwise, employing the main thread to obtain an image adapted to the capacity of the main cache from an image chain, and to render the image; and

displaying the image rendered.

In one embodiment, the method further includes the step of: when it is not required to cache the image into the main cache, employing the main thread to obtain the image directly from the main cache, and to render the image.

In one embodiment, the step of obtaining an image adapted to the capacity of the main cache from an image chain specifically includes: determining whether an image chain of the image has been created; if yes, employing the main thread to obtain an image adapted to the capacity of the main cache from the image chain, and to render the image; otherwise, employing the main thread to create an image chain, to obtain an image adapted to the capacity of the main cache from the image chain, and to render the image.

In one embodiment, the method further includes, after determining that the image chain of the image has been created, the step of: determining whether the image chain is in the sub-cache; if yes, employing the main thread to obtain an image adapted to the capacity of the main cache from the image chain in the sub-cache, and to render the image; otherwise, employing the main thread to cache the image chain created into the sub-cache; when it is determined that the image chain of the image hasn't yet been created, employing the main thread to create the image chain, to cache the image chain created into the sub-cache, to obtain the image adapted to the capacity of the main cache from the image chain in the sub-cache, and to render the image.

In one embodiment, the preset condition is selected from any of the followings:

it is the first time that an image is rendered;

the size of the image is larger than the capacity of the main cache; and

the user is performing operations of image scaling or dragging.

In one embodiment, when it is required to cache an image into the main cache, and it is not the first time that an image is rendered, the method further includes the step of: employing a sub-thread to create an image and to cache the image created into the main cache; employing the main thread to obtain the image created from the main cache, and to render the image.

By the above image browsing method, system and computer storage medium, when it is required to cache an image into a main cache and it is the first time that an image is rendered, the image is cached into the main cache, obtained from main cache, and is rendered; when it is required to cache the image into the main cache and it is not the first time that an image is rendered, the image is obtained from the image chain, and is rendered. Selecting an appropriate image from an image chain which is a string of images of different sizes can realize fast rendering, which avoids unsmooth browsing of the image due to time-consuming creation of the images to be rendered. Thus, a user can browse the images more smoothly. Meanwhile, by employing the main thread to obtain an image from the image chain in the sub-cache, and the sub-thread to create the image, the rendering burden of the each thread is reduced respectively; moreover, double caching facilitates easy and rapid accessing of images to be rendered, allowing the overall image browsing process to be smoother.

### BRIEF DESCRIPTION OF THE DRAWINGS

FIG. 1 is the flow chart of the method for image browsing in one embodiment of the present invention;

FIG. 2 is the flow chart of the method for image browsing in another embodiment of the present invention;

FIG. 3 is the schematic structure chart of the system for image browsing in one embodiment of the present invention.

### DETAILED DESCRIPTION OF THE PREFERRED EMBODIMENTS

The invention will be better understood with reference to the following description taken in conjunction with the specific embodiments and the accompanying drawings.

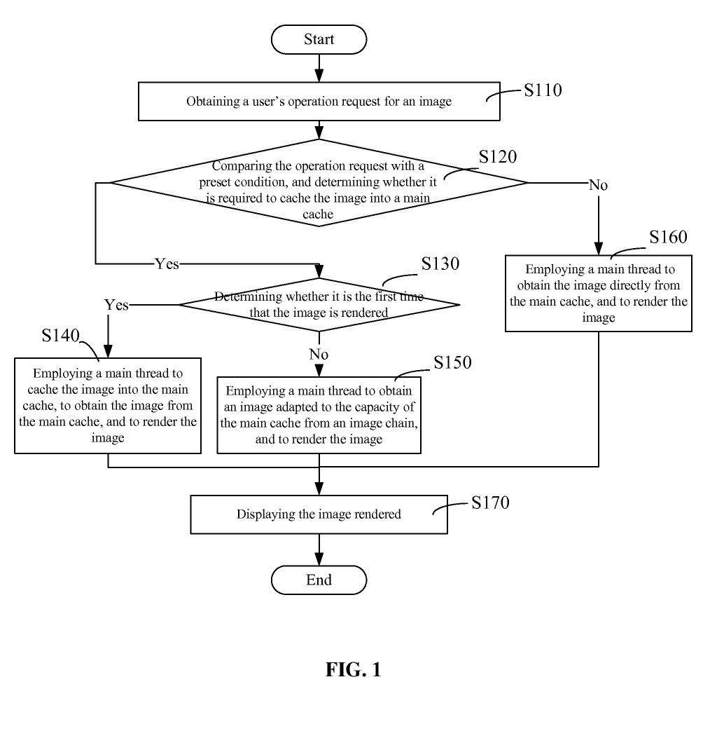

In one embodiment, as shown in FIG. 1, a method for image browsing includes the steps of:

Step S100: obtaining a user's operation request for an image.

Users' operation requests for an image may be operations of image viewing, scaling and dragging. Operation request may contain first rendering information, image size information and scaling information, etc.

Step S120: compare the operation request with a preset condition, and determine whether it is required to cache the image into a main cache; if yes, perform step S130; otherwise, perform step S160.

It is part of the source image that is stored in the main cache. When the part to be rendered exceeds the part that has been stored in the main cache, it is required to cache the image into the main cache, wherein both the image to be cached and the image already been stored in the main are part of the same source image. Caching means the operation of scaling and clipping an image, and loading the image data from a memory to a video memory. Memory refers to the D3DPOOL_SYSTEMMEM resource pool in D3D, wherein the resources stored in D3DPOOL_SYSTEMMEM resource pool cannot be accessed directly by devices. Video memory refers to the D3DPOOL_DEFAULT resource pool in D3D; since the D3DPOOL_DEFAULT resource pool is created in the video memory, it does use the system memory, but has to be recreated in case the device is lost. The main cache is used to store images of which the definition conforms to the preset standard.

In one embodiment, the preset condition is selected from any of the followings:

(1) It is the first time that an image is rendered.

The user performs operation to an image. According to the operation, if it is the first time that the image is rendered, it is required to cache the image into a main cache, so as to employ a main thread to obtain the image from the main cache and to render the image.

(2) The size of the image is larger than the capacity of the main cache. When an image size is larger than the capacity of the main cache, the image cannot be cached entirely into the main cache; it is required to scale the image into a size adapted to the capacity of the main cache, and then cache it into the main cache.

(3) The user is performing operations of image scaling or dragging.

When a user is performing the scaling operation, the creation of a new image having definition conforming to a preset standard will be relatively slow; thus, the efficiency of extracting an image from the main cache will be low. If an image is obtained from an image chain, the operation will be faster, for the scaling extent will not be too large. An image chain is a string of images created by Mipmap image processing technology, wherein each image in the image string has a size a quarter of the previous image, i.e., half of the length and width of the previous image. Definition of the images in the image chain does not conform to the preset standard.

Step S130: further determine whether it is the first time that the image is rendered; if yes, perform step S140; otherwise, perform step S150.

Step S130: employ a main thread to cache the image into the main cache, to obtain the image from the main cache, and to render the image.

If it is the first time that the image is rendered, employing the main thread to cache the image created into the main cache, to obtain the image from the main cache, and to render the image.

Step S150: employ the main thread to obtain an image adapted to the capacity of the main cache from the image chain, and render the image.

The main thread obtains the image from the image chain and renders the image; the definition of the image rendered does not conform to the preset standard, and will be displayed temporarily after rendered. After the image conforming to the preset standard is created and cached into the main cache, the image created is obtained from the main cache and is rendered, so as to be displayed as an image conforming to the standard.

Step S160: employ the main thread to obtain the image directly from the main cache, and render the image.

In case it is not required to cache an image into a main cache, i.e., neither of the requirements of (1) to (3) is met with, an image can be obtained directly from the main cache, and rendered.

Step S170: display the image rendered.

The image rendered is displayed to be viewed by the user.

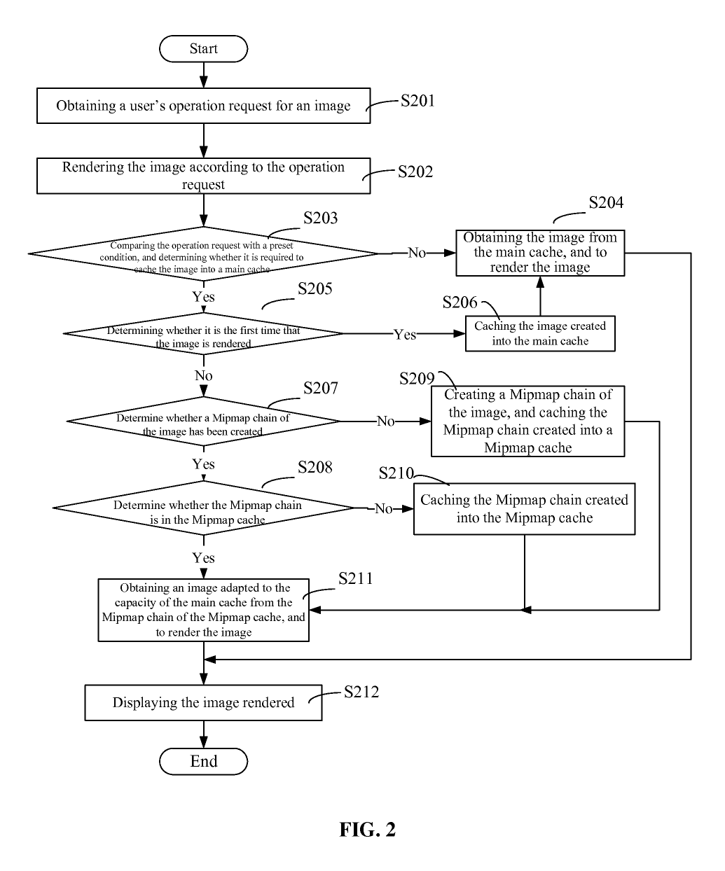

FIG. 2 is the flow chart of the method for image browsing in another embodiment. The method includes the step of:

step S201: obtaining a user's operation request for an image.

Users' operation requests for an image may be operations of image viewing, scaling and dragging. Operation request may contain first rendering information, image size information and scaling information, etc.

Step S202: compare the operation request with a preset condition, and determine whether it is required to cache the image into a main cache; if yes, perform step S204; otherwise, perform step S203.

It is part of the source image that is stored in the main cache. When the part to be rendered exceeds the part that has been stored in the main cache, it is required to cache the image into the main cache, wherein both the image to be cached and the image already been stored in the main are part of the same source image. Caching means the operation of scaling and clipping an image, and loading the image data from a memory to a video memory. Memory refers to the D3DPOOL_SYSTEMMEM resource pool in D3D, wherein the resources stored in D3DPOOL_SYSTEMMEM resource pool cannot be accessed directly by devices. Video memory refers to the D3DPOOL_DEFAULT resource pool in D3D; since the D3DPOOL_DEFAULT resource pool is created in the video memory, it does use the system memory, but has to be recreated in case the device is lost. The main cache is used to store images of which the definition conforms to the preset standard.

Step S203: employ a main thread to obtain the image from the main cache, and render the image.

Step S204: further determine whether it is the first time that the image is rendered; if yes, perform step S205; otherwise, perform step S206.

In one embodiment, the method further includes, in the same time of step S206, the step of: creating an image, caching the image created into the main cache, and obtaining the image created from the main cache, and rendering the image. Rendering of the image with definition conforming to the preset standard is realized by a sub-thread.

Step S205: employ the main thread to cache the image into the main cache, and perform step S203.

If it is the first time rendering the image, then employ the main thread to cache the image created into the main cache, and to obtain the image from the main cache, and render the image.

Step S206: determine whether an image chain of the image has been created; if yes, perform step S207; otherwise, perform step S208.

Determining whether an image chain of the image has been created; if yes, obtaining the image adapted to the capacity of the main cache directly from the image chain, and rendering the image, or further determining whether the image chain is in the sub-cache; if the image chain hasn't been created yet, creating the image chain, obtaining the image adapted to the capacity of the main cache from the image chain, and rendering the image, or caching the image chain into a sub-cache. The image chain is stored in the sub-cache.

Step S207: determine whether the image chain is in the sub-cache; if yes, perform step S210; otherwise, perform step S209.

Employment of the sub-cache can rapidly cache images that do not conform to preset standard, which facilitates the main thread to obtain images that do not conform to preset standard from the sub-cache, and to render the image, thus allowing smooth operations.

Step S208: employ the main thread to create an image chain of the image, and cache the image chain created into a sub-cache.

Step S209: employ the main thread to cache the image chain created into the sub-cache.

Step S210: employ the main thread to obtain the image adapted to the capacity of the main cache from the image chain in the sub-cache, and render the image.

The image obtained from the image chain to be rendered does not conform to the definition standard; the image rendered is temporarily displayed, so as to create an image having definition conforming to the preset standard. After caching the image into the main cache, image having definition conforming to the preset standard is obtained from the main cache, and is rendered; thus, an image having definition conforming to the preset standard is displayed.

Step S211: display the render image.

The image rendered is displayed to be viewed by the user.

In addition, the present invention also provides a computer storage medium for storing computer-executable instruction(s). The computer-executable instructions are configured to execute a method for browsing image, wherein the steps included in the method for browsing image executed by the computer-executable instructions stored in the computer storage medium are the same as those described above, and will not go into details here.

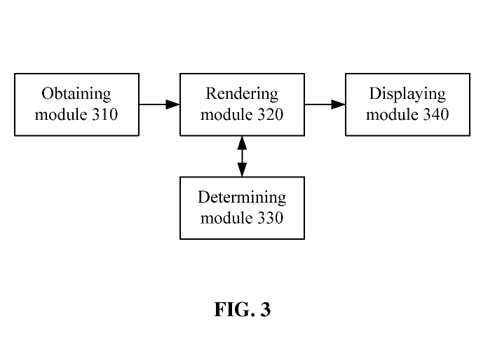

As shown in FIG. 3, a system for image browsing system includes an obtaining module 310, a rendering module 320, a determining module 330 and a display module 340.

The obtaining module 310 is configured to obtain a user's operation request for an image. Users' operation requests for an image may be operations of image viewing, scaling and dragging. Operation request may contain first rendering information, image size information and scaling information, etc.

The rendering module 320 is configured to render an image according to the operation request.

The determining module 330 is configured to compare the operation request with a preset condition, and to determine whether it is required to cache the image into a main cache, and whether it is the first time that an image is rendered.

When the determining module 330 determines that it is required to cache the image into the main cache, and it is the first time that the image is rendered, the rendering module 320 employs a main thread to cache the image into the main cache and to obtain the image from the main cache, and renders the image. When it is the first time that the image is rendered, the rendering module 320 employs the main thread to cache the image created into the main cache and to obtain the image from the main cache, and renders the image.

When the determining module 330 determines that it is required to cache the image into the main cache, and it is not the first time that the image is rendered, the rendering module 320 employs the main thread to obtain an image adapted to the capacity of the main cache from an image chain, and renders the image. The rendering module 320 employs the main thread to obtain the image from the image chain, of which the definition does not conform to the preset standard. The image rendered will be displayed temporarily. After the image conforming to the preset standard is created and cached into the main cache, the created image is obtained from the main cache and rendered, so as to be displayed by the display module 340 as an image conforming to the standard.

When the determining module 330 determines that it is required to cache the image into the main cache, and it is not the first time that the image is rendered, the rendering module 320 employs a sub-thread to create the image and to cache the image created into the main cache, and employs the main thread to obtain the image created from the main cache, and renders the image. The definition of the image created conforms to preset standard.

When the user is performing an image scaling operation, three types of image scaling functions can be employed: StretchDIBits, D3DXLoadSurfaceFromMemory and D3DXLoadSurfaceFromSurface. StretchDIBits is fast and uninterruptable, commonly used to create a clear scaled image in multi-thread; D3DXLoadSurfaceFromMemory and D3DXLoadSurfaceFromSurface are slow but interruptible, used to cache an image into a sub-cache. Rendering of the scaling operation usually use an image from the image chain to render, which is very fast.

When the user is performing an image dragging operation, the image can be rendered directly without the need to re-cache for the main cache has enough capacity during the dragging operation, which high efficiency. When the user is dragging intensively, rendering images from an image chain will be more efficient.

In a preferred embodiment, when the determining module 330 determines that it is required to cache an image into the main cache, and it is not the first time that an image is rendered, the determining module 330 is also configured to further determine whether to create an image chain of the image; if yes, the rendering module 320 employs the main thread to obtain the image adapted to the capacity of the main cache from the image chain, and renders the image; otherwise, the rendering module 320 employs the main thread to create the image chain and to obtain the image adapted to the capacity of the main cache from the image chain, and renders the image.

In a preferred embodiment, the determining module 330 is also configured to, after determining that the image chain has been created, further determine whether the image chain is in a sub-cache; if yes, the rendering module 320 employs the main thread to obtain the image adapted to the capacity of the main cache from the image chain in the sub-cache, and renders the image; otherwise, the rendering module 320 employs the main thread to cache the image created into the sub-cache. Employing the sub-cache can rapidly caches images that do not conform to preset standard, which facilitates the rendering module 320 to obtain images that do not conform to preset standard from the sub-cache, and to render the images, thus allowing smooth user operations.

When the determining module 330 determines that the image chain of the image hasn't been created yet, the rendering module 320 is also configured to create the image chain, to cache the image chain created into the sub-cache, to obtain the image adapted to the capacity of the main cache from the image chain in the sub-cache, and to render the image.

When the determining module 330 determines that it is not required to cache the image into the main cache, the rendering module 320 obtains the image directly from the main cache, and renders the image.

It is part of the source image that is stored in the main cache. When the part to be rendered exceeds the part that has been stored in the main cache, it is required to cache the image into the main cache, wherein both the image to be cached and the image already been stored in the main are part of the same source image. Caching means the operation of scaling and clipping an image, and loading the image data from a memory to a video memory. Memory refers to the D3DPOOL_SYSTEMMEM resource pool in D3D, wherein the resources stored in D3DPOOL_SYSTEMMEM resource pool cannot be accessed directly by devices. Video memory refers to the D3DPOOL_DEFAULT resource pool in D3D; since the D3DPOOL_DEFAULT resource pool is created in the video memory, it does use the system memory, but has to be recreated in case the device is lost. The main cache is used to store images of which the definition conforms to the preset standard.

In one embodiment, the preset condition is selected from any of the followings.

(1) It is the first time that an image is rendered.

The user performs operation to an image. According to the operation, if it is the first time that the image is rendered, it is required to cache the image into a main cache, so as to employ a main thread to obtain the image from the main cache, and to render.

(2) The size of the image is larger than the capacity of the main cache.

When an image size is larger than the capacity of the main cache, the image cannot be cached entirely into the main cache; it is required to scale the image into a size adapted to the capacity of the main cache, and then cache it into the main cache.

(3) The user is performing operations of image scaling or dragging.

When a user is performing the scaling operation, the creation of a new image having definition conforming to a preset standard will be relatively slow; thus, the efficiency of extracting an image from the main cache will be low. If an image is obtained from an image chain, the operation will be faster, for the scaling extent will not be too large. An image chain is a string of images created by Mipmap image processing technology, wherein each image in the image string has a size a quarter of the previous image, i.e., half of the length and width of the previous image. Definition of the images in the image chain does not conform to the preset standard.

The display module is configured to display the image rendered.

By the above image browsing method, system and computer storage medium, when it is not required to cache an image into a main cache, the image is obtained directly from the main cache and rendered; when it is required to cache an image into the main cache and it is the first time that an image is rendered, the image is cached into the main cache and obtained from the main cache, and is rendered; when it is required to cache the image into the main cache and it is not the first time that an image is rendered, the image is obtained from the image chain, and is rendered. Selecting an appropriate image from an image chain which is a string of images of different sizes can realize fast rendering, which avoids unsmooth browsing of the image due to time-consuming creation of the images to be rendered. Thus, a user can browse the images more smoothly.

In addition, creating the image by the sub-thread and rendering the image by the main thread, the rendering efficiently is further enhanced, ensuring smooth image browsing.

The embodiments are chosen and described in order to explain the principles of the invention and their practical application so as to allow others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for image browsing, comprising:
obtaining a user's operation request for an image;
comparing the operation request with a preset condition, and determining whether it is required to cache the image into a main cache;
when it is required to cache the image into the main cache, further determining whether it is the first time that the image is rendered; if yes, employing a main thread to cache the image into the main cache, to obtain the image from the main cache, and to render the image; otherwise, employing a main thread to obtain an image adapted to the capacity of the main cache from an image chain, and to render the image; and
displaying the image rendered.

2. The method of claim 1, further comprising:
when it is not required to cache the image into the main cache, employing a main thread to obtain the image directly from the main cache, and to render the image.

3. The method of claim 1, wherein obtaining an image adapted to the capacity of the main cache from an image chain comprises: determining whether an image chain of the image has been created; if yes, employing the main thread to obtain an image adapted to the capacity of the main cache from the image chain, and to render the image; otherwise, employing the main thread to create the image chain, to obtain an image adapted to the capacity of the main cache from the image chain, and to render the image.

4. The method of claim 3, further comprising: after determining whether an image chain of the image has been created, determining whether the image chain is in a sub-cache; if yes, employing the main thread to obtain an image adapted to the capacity of the main cache from the image chain in the sub-cache, and to render the image; otherwise, employing the main thread to cache the image chain created into the sub-cache; when it is determined that the image chain of the image has not yet been created, employing the main thread to create an image chain of the image, to cache the image chain created into a sub-cache, to obtain the image adapted to the capacity of the main cache from the image chain in the sub-cache, and to render the image.

5. The method of claim 1, wherein the preset condition is selected from the group consisting of:
it is the first time that an image is rendered,
the size of the image is larger than the capacity of the main cache, and
the user is performing operations of image scaling or dragging.

6. The method of claim 1, wherein when it is required to cache an image into the main cache, and it is not the first time that the image is rendered, the method further comprises: employing a sub-thread to create an image, and to cache the image created into the main cache; employing the main thread to obtain the image created from the main cache, and to render the image.

7. A system for image browsing, comprising:
an obtaining module, configured to obtain a user's operation request for an image;
a determining module, configured to compare the operation request with a preset condition, and to determine whether it is required to cache the image into a main cache, and whether it is the first time that an image is rendered;
when the determining module determines that it is required to cache the image into the main cache, and it is the first time that the image is rendered, a rendering module employs a main thread to cache the image into the main cache, to obtain the image from the main cache, and to render the image; when the determining module determines that it is required to cache the image into the main cache, and it is not the first time that the image is rendered, the rendering module employs the main thread to obtain an image adapted to the capacity of the main cache from an image chain, and to render the image; and
a display module, configured to display the image rendered.

8. The system of claim 7, wherein when the determining module determines that it is not required to cache the image into the main cache, the rendering module employs the main thread to obtain the image directly from the main cache, and to render the image.

9. The system of claim 7, wherein the determining module is further configured to determine whether an image chain of the image has been created; if yes, the main thread module is configured to obtain an image adapted to the capacity of the main cache from the image chain, and to render the image; otherwise, the main thread module is configured to create an image chain, to obtain an image adapted to the capacity of the main cache from the image chain, and to render the image.

10. The system of claim 9, wherein the determining module is also configured to further determine, after determining that the image chain of the image has been created, whether the image chain is in a sub-cache; if yes, the rendering module employs the main thread to obtain an image adapted to the capacity of the main cache from the image chain in the sub-cache, and renders the image; otherwise, the rendering module employs the main thread to cache the image chain created into the sub-cache; when the determining module determines that the image chain of the image hasn't been created yet, the rendering module employs the main thread to create the image chain, to cache the image chain created into a sub-cache, then to obtain the image adapted to the capacity of the main cache from the image chain in the sub-cache, and renders the image.

11. The system of claim 7, wherein the preset condition is selected from the group consisting of:
it is the first time that an image is rendered,
the size of the image is larger than the capacity of the main cache, and
the user is performing operations of image scaling or dragging.

12. The system of claim 7, wherein the determining module determines that it is required to cache the image into the main cache, and it is not the first time that an image is rendered, the rendering module employs a sub-thread to create an image, and to cache the image created into the main cache; then the rendering module employs the main thread to obtain the image created from the main cache, and renders the image.

13. A non-transitory computer-readable storage medium storing computer-executable instructions which, when executed by one or more computer processors, cause the one or more computer processors to perform a method of image browsing, comprising:
obtaining a user's operation request for an image;
comparing the operation request with a preset condition, and determining if it is required to cache the image into a main cache;
when it is required to cache the image into the main cache, further determining if it is the first time that the image is rendered; if yes, employing a main thread to cache the image into the main cache, to obtain the image from the main cache, and to render the image; otherwise, employing the main thread to obtain an image adapted to the capacity of the main cache from an image chain, and to render the image; and
displaying the image rendered.

14. The computer-readable storage medium of claim 13, wherein the method further comprises when it is not required to cache the image into the main cache, employing the main thread to obtain the image directly from the main cache, and to render the image.

15. The computer-readable storage medium of claim 13, wherein obtaining an image adapted to the capacity of the main cache from an image chain comprises: determining whether an image chain of the image has been created; if yes, employing the main thread to obtain an image adapted to the capacity of the main cache from the image chain, and to render the image; otherwise, employing the main thread to create the image chain, to obtain an image adapted to the capacity of the main cache from the image chain, and to render the image.

16. The computer-readable storage medium of claim 15, wherein the method further comprises : after determining whether an image chain of the image has been created, determining whether the image chain is in a sub-cache; if yes, employing the main thread to obtain an image adapted to the capacity of the main cache from the image chain in the sub-cache, and to render the image; otherwise, employing the main thread to cache the image chain created into the sub-cache; when it is determined that the image chain of the image hasn't yet been created, employing the main thread to create an image chain of the image, to cache the image chain created into a sub-cache, to obtain the image adapted to the capacity of the main cache from the image chain in the sub-cache, and to render the image.

17. The computer-readable storage medium of claim 13, wherein the preset condition is selected from the group consisting of:
it is the first time that an image is rendered,
the size of the image is larger than the capacity of the main cache, and
the user is performing operations of image scaling or dragging.

18. The computer-readable storage medium of claim 13, wherein the method further comprises when it is required to cache an image into the main cache, and it is not the first time that an image is rendered, employing a sub-thread to create an image, and to cache the image created into the main cache; employing the main thread to obtain the image created from the main cache, and to render the image.
